(19) United States
(12) Patent Application Publication
(10) Pub. No.: US 2004/0099730 A1
(43) Pub. Date: May 27, 2004

(54) System and method of personalizing financial transaction cards

(75) Inventors: James A. Tuchler, Northbrook, IL (US); Kelly Hill, Rolling Meadows, IL (US); Dennis J. Honan, Cary, IL (US)

Correspondence Address: MICHAEL BEST & FRIEDRICH, LLP, 100 E WISCONSIN AVENUE, MILWAUKEE, WI, 53202, US

(73) Assignee: Sears, Roebuck and Co., Hoffman Estates, IL

(21) Appl. No.: 10/306,713

(22) Filed: Nov. 27, 2002

(51) Int. Cl. G06K 5/00

(52) U.S. Cl. 235/380

(57) ABSTRACT

A method of making a personalized financial transaction card having a customer-specified image on the card. The method includes providing a programming station for access by the customer. The programming station includes a data entry tool. The method also includes providing a card account management system connected to the programming station. The card account management system includes a database of account data relating to the customer. The method further includes entering data representing the customer-specified image into the programming station using the data entry tool, transmitting the data from the programming station to the card account management system, and generating a personalized financial transaction card related to the account data and bearing the customer-specified image on the personalized financial transaction card.

### FIELD OF THE INVENTION

The present invention relates to transaction cards, and more particularly to a method of personalizing transaction cards to include customized images and text.

### BACKGROUND OF THE INVENTION

Credit cards and debit cards are increasingly common and are widely used, in part, because they allow a consumer to make purchases without requiring the consumer to use or carry cash. Many retailers have begun issuing gift cards, which are designed to replicate the convenience of credit cards and debit cards. Gift cards are generally stored value cards that may or may not be replenished, and may or may not have “smart card” functionality. A smart card is a card which, in addition to allowing one to purchase goods, also has a computer chip thereon for storing data personal to the user. Smart cards are often used to allow the user to enter restricted areas, access medical, financial or other information or perform other operations requiring the data stored on the chip.

Gift cards commonly include front and back sides and are sized to resemble credit cards. The front side of the card generally includes a raised alphanumeric identification number, which identifies the cardholder's account. Additionally, the front side generally includes a design or illustration that is particular to a given issuer. Generally, the design is the same for all cardholders and includes the name and/or trademark of the issuer. The back side of the card usually contains a magnetic strip on which information about the cardholder's account is encoded. Additionally, the back side of the card often includes a space for the cardholder's signature and directions for using the card and/or for contacting the card issuer.

When a gift card is purchased, the card issuer normally opens an account, which corresponds to the alphanumeric code imprinted on the card. An amount of money corresponding to the purchase price of the gift card is credited to the account. After the card is purchased and the account is opened, the purchaser can give the card as a gift to a cardholder. The cardholder can then use the card in the issuer's stores instead of cash. Additionally, retailers that have more than one store commonly store the cardholder's account information on a network so that the card can be used at any one of the retailer's many stores.

### SUMMARY OF THE INVENTION

While the above described gift cards are generally effective, conventional gift cards are often perceived as relatively impersonal. For this reason many purchasers are reluctant to give them as gifts.

To address these and other concerns with conventional gift cards, the invention provides a method of personalizing gift cards, which includes allowing a customer to upload a customer-specified image onto the internet from a first location, download the customer-specified image (e.g., a digital photograph file) from the internet to a second location (e.g., a customer service department) and apply the image to a gift card. Alternatively, the method can include receiving or crediting a customer specified image (including a photograph) at a designated location, such as a store or a kiosk, and applying the image to a gift card.

The present invention provides a method of making a personalized financial transaction card having a customer-specified image on the card includes providing a programming station for access by the customer. The programming station includes a data entry tool. The method also includes providing a card account management system connected to the programming station. The card account management system includes a database of account data relating to the customer. The method further includes entering data representing the customer-specified image into the programming station using the data entry tool, transmitting the data from the programming station to the card account management system, and generating a personalized financial transaction card related to the account data and bearing the customer-specified image on the personalized financial transaction card.

The present invention also provides a system for allowing a customer to make a personalized financial transaction card having a customer-specified image on the card. The system includes a programming station including a data entry tool that allows the customer to enter into the programming station data representing the customer-specified image, and a card account management system connected to the programming station. The card account management system includes a database of account data relating to the customer and means for generating a personalized financial transaction card related to the account data and bearing the customer-specified image on the personalized financial transaction card.

The present invention further provides a software program stored on computer readable medium for generating a virtual site accessible by a customer and for generating a financial transaction card based on information provided by the customer. The software program includes a program module for acquiring and storing image or text data specified by the customer, a program module for assigning a monetary value based on a monetary value data entered by the customer, and a program module for combining the image or text data with the monetary value data and generating a financial transaction card bearing the image or text data on the face of the card and having the monetary value encoded on the card.

The present invention also provides an internet website accessible by a customer desiring to purchase a financial transaction card. The website includes a graphical user interface including means for inputting a customer provided image or text for ultimate transfer to the face of the financial transaction card.

The present invention further provides a point-of-purchase gift card dispenser including a digital camera for acquiring an image presented by a customer purchasing the gift card, a tool for accepting a monetary value paid by the customer for the gift card, and a card dispenser for combining the image on the face of the gift card, encoding the monetary value on the gift card, and dispensing the gift card to the customer at the point of purchase.

Other features and advantages of the invention will become apparent to those skilled in the art upon review of the following detailed description, claims, and drawings.

### BRIEF DESCRIPTION OF THE DRAWINGS

The present invention is further described with reference to the accompanying drawings, which show various embodiments of the present invention. However, it should be noted that the invention as disclosed in the accompanying drawings is illustrated by way of example only. The various elements and combinations of elements described below and illustrated in the drawings can be arranged and organized differently to result in embodiments which are still within the spirit and scope of the present invention.

FIG. 1 is a front view of a gift card according to the present invention;

FIG. 2 is a rear view of the gift card shown in FIG. 1;

FIG. 3 is a diagram detailing one embodiment of a system according to the present invention;

FIGS. 4A-4C are flowcharts illustrating a gift card issuing process effected by the embodiment shown in FIG. 3;

FIG. 5 is a diagram detailing another embodiment of a system according to the present invention;

FIGS. 6A-6D are flowcharts illustrating a gift card issuing process effected by the embodiment shown in FIG. 5; and

FIGS. 7A-7L show a graphical user interface according to one embodiment of the present.

### DETAILED DESCRIPTION

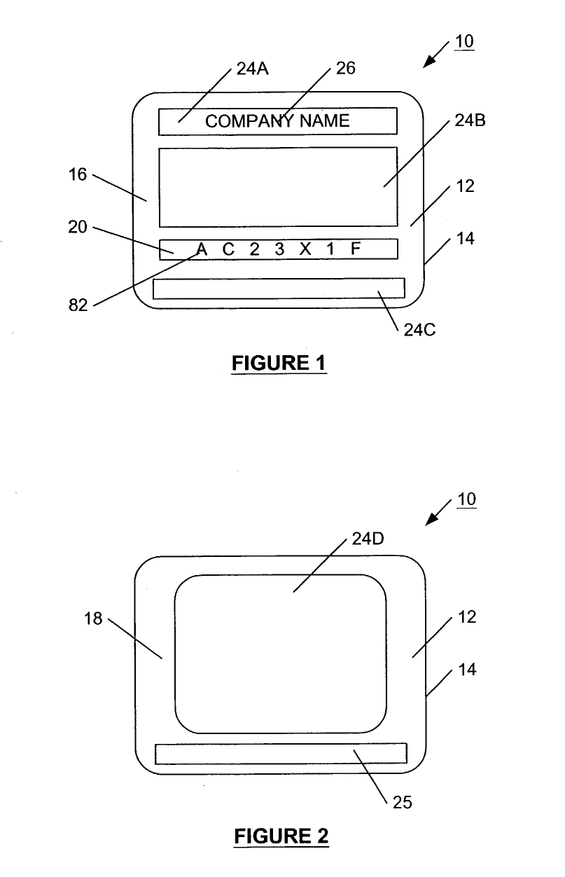

FIGS. 1 and 2 illustrate a personalized financial transaction card or gift card 10 according to the present invention. The gift card 10 includes a plastic card body 12 having an outer perimeter 14, a front side 16, and a back side 18. The card body 12 is sized to be similar to credit cards and debit cards and can be stored in a wallet or a purse. The front side 16 includes an identification number field 20 and three data fields 24A, 24B, 24C. The back side 18 includes a fourth data field 24D. One having ordinary skill in the art will appreciate that the front and back sides 16, 18 could alternatively include one, two, three, five, or more data fields and that the location of the data fields can be changed to a significant degree, as explained in greater detail below.

In the illustrated embodiment, the first data field 24A includes the name and perhaps trademark 26 of a card issuer (e.g, a store name, the name of a shopping mall, and the like). The second data field 24B and the third data field 24C are user specified data fields and may include images and/or text as specified by a customer. The fourth data field 24D includes directions and instructions, explaining how and where the card 10 can be used. A magnetic strip 25 extends across the bottom of the back side 18 and stores identification and account information. Further identification and account information can be printed on the card 10, stored in an optical data carrier (e.g., a bar code), or can be incorporated in a memory chip, which can be imbedded in the card body 12.

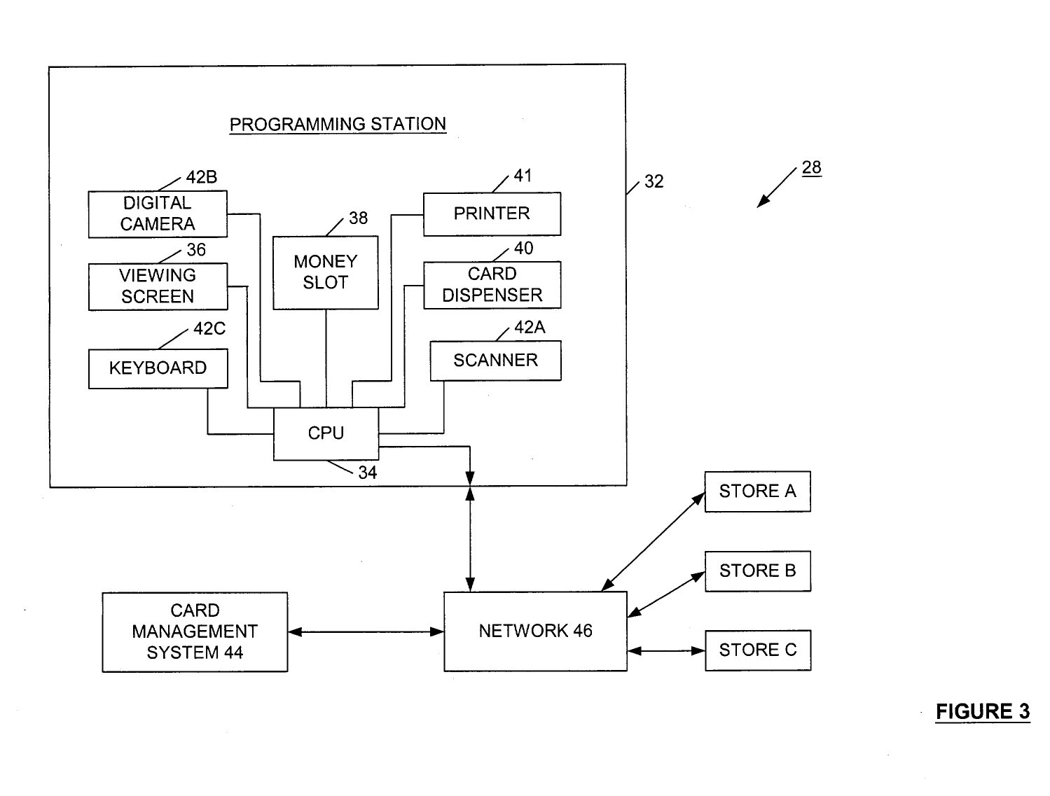

FIG. 3 illustrates a card personalization system 28, including a programming station 32 (e.g., a personal computer, a dedicated network terminal, a point of sale terminal, a handheld computer, a cellular phone, a personal data assistant, and the like). In the illustrated embodiment, the programming station 32 is located in a retail establishment. However, as described in greater detail below, the programming station 32 can be located in a number of locations, including but not limited to stores, kiosks, shopping malls, and other public places.

In the embodiment illustrated in FIG. 3, the programming station 32 includes a central processing unit (“CPU”) 34, which manages the operations and communications of the programming station 32. As is commonly known in the art, the CPU 34 may be a single integrated circuit designed specifically as an ASIC to effect all necessary processing and communications functions. Alternatively, the CPU 34 may include a collection of discrete electronic components for effecting the processing and communications functions separately. The programming station 32 also includes a viewing screen 36, a money slot 38 or credit/debit card swipe (for entering a monetary value into the programming station 32), a card dispenser 40, and a printer 41 all connected to the CPU. The programming station 32 also includes three data entry tools 42 for entering or uploading data, in the form of text messages and/or graphic images, into the programming station 32. More specifically, the programming station 32 includes a scanner 42A, a digital camera 42B, and a keyboard 42C. In other embodiments (not shown), the programming station 32 can also or alternately include other data entry tools 42 (e.g., a CD-ROM drive, a disk drive, a touch-screen, a mouse, and the like) for uploading or entering data into the programming station 32, or the programming station 32 may include only one or any number of the aforementioned data entry tools 42 in any combinations.

The programming station 32 communicates through the CPU with a card management system 44 (e.g., a network server, a computer database, a personal computer, a super computer, and the like) over a network 46 in accordance with a standardized communication protocol and/or a standardized object protocol, depending on the type of network and the type of data being transmitted. The card management system 44 stores account information and customer profile information (e.g., addresses, billing information, phone numbers, spending history, credit history, and the like). Additionally, the card management system 44 stores card information, such as, for example, card identification numbers, the number of cards issued, the next available card identification number, card activation codes, and the like.

In different applications of the present invention, the network 46 can be the internet, the World Wide Web, a local area network, a wide area network, a dedicated phone or cable line, or another similar communication network. In this manner, the programming station 32 and the card management system 44 can be remotely located, such as, for example, in different cities, states, or countries. In other embodiments (not shown), the network 46 can connect a number of programming stations 32 to one or more card management systems 44, or one or more of the programming stations 32 can be located remote from the card management system(s) 44, or one or more of the programming stations 32 can be adjacent to or integrated within the card management system(s) 44. Alternatively, and notwithstanding that they are shown separately in FIG. 3, the card management system 44 and the programming station 32 can be adjacent to or integrated within each other in a single store or kiosk and can communicate across a cable or wire (not shown).

Retail establishments, such as, for example, stores A, B, and C are also linked to the network 46. The stores A, B, C can communicate with each other and with the card management system 44 via the network 46 and can exchange financial information, customer data, inventory information, and the like across the network 46. In other applications (not shown), the stores A, B, C can use a second secure network to communicate with one another and with the card management system 44.

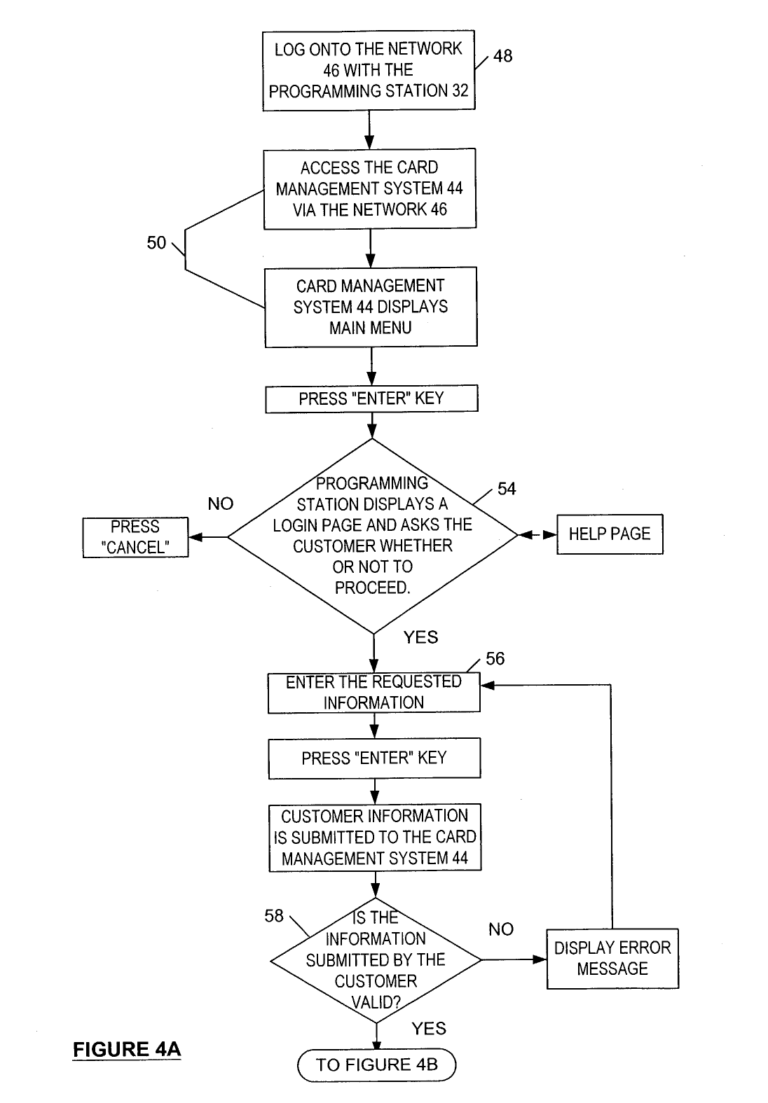

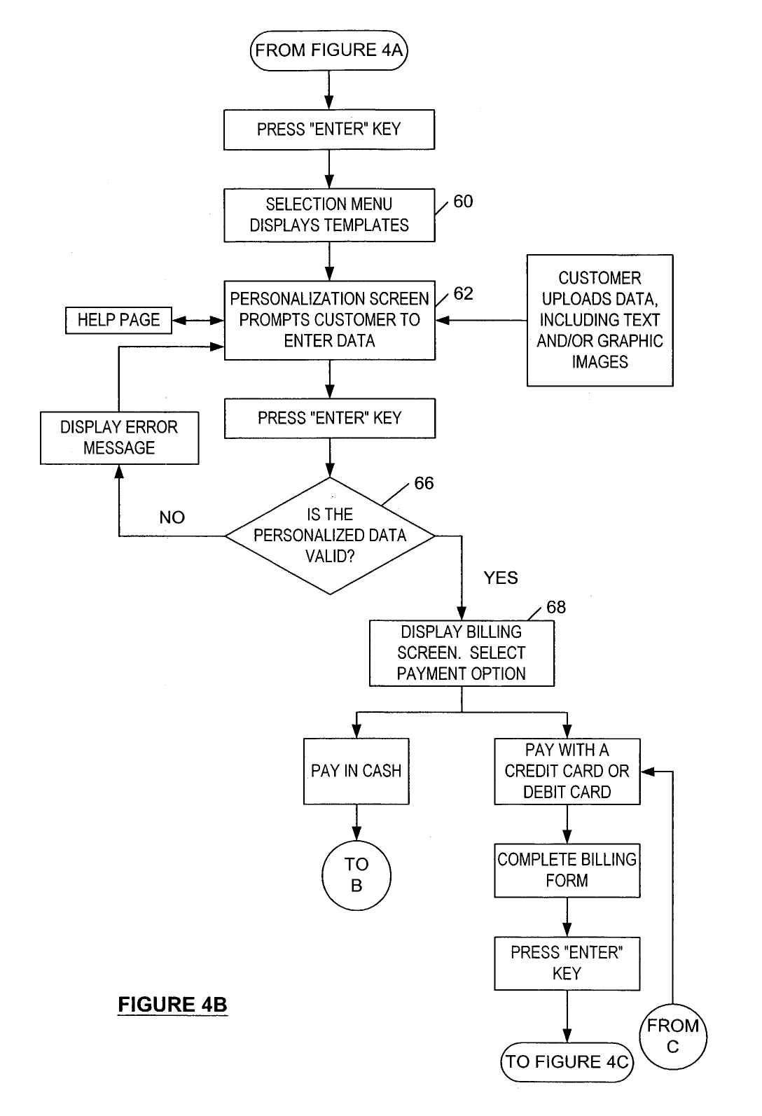

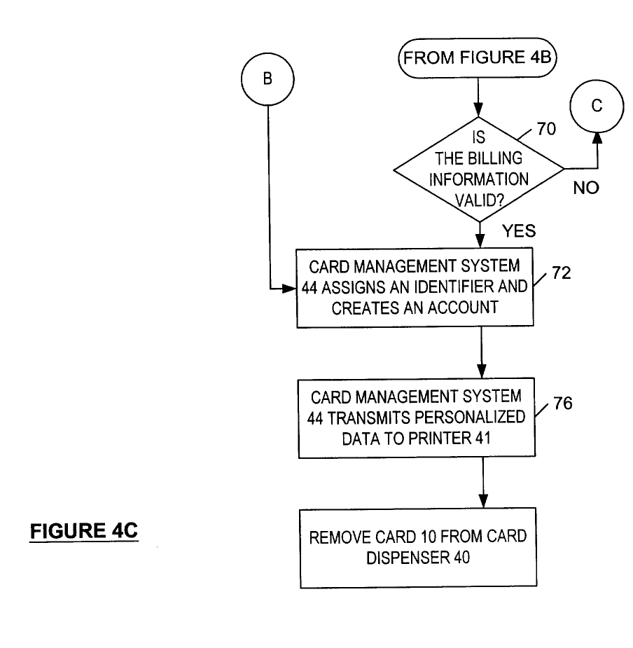

FIGS. 4A-4C show a flow chart illustrating a method for personalizing the gift card 10 with the card personalization system 28 according to a first preferred embodiment of the present invention. In act 48, the customer approaches the programming station 32 and logs onto the network 46. In act 50, the customer accesses the card management system 44 via the network 46. The programming station 32 then displays a main menu on the viewing screen 36. The main menu includes instructions for personalizing the gift card 10 and can include other descriptive or instructional materials. For example, the main menu can include advertisements for other products, legal disclaimers, and pictures of personalized gift cards 10 made according to the following method. After the customer has reviewed the instructions, directions, and advertisements, the main menu prompts the customer to press the “enter” key (located on the keyboard 42C) to move to the next screen.

In act 54, the programming station 32 displays a login page. The login page includes instructions for creating a personalized account, a number of data entry fields and a link to a help page. At this point the customer can proceed and provide the requested information (“YES” at act 54) or the customer can press a “cancel” button and exit the system (“NO” at act 54). If the customer is interested in proceeding, the customer is instructed to follow the instructions displayed on the login page and to enter the requested information into the data entry fields in act 56. The login page includes data entry fields for the customer to enter her name, mailing address, telephone number, the name of the intended recipient, and the amount of money that the customer would like credited to the gift card 10. Once the customer provides the required information, the customer is prompted to press the “enter” key to proceed to the next screen. The programming station 32 then submits the customer information to the card management system 44 via the network 46.

As shown in act 58, the card management system 44 verifies the customer information, determines if the customer information is valid by comparing the customer information to a preprogrammed template or format, and verifies the information for the correct syntax in a known manner. If any of the customer information is determined to be invalid (“NO” at act 58), an error message is displayed and the customer is prompted to re-enter or correct that information. If the information is valid (“YES” at act 58), the customer is allowed to proceed to a selection menu by pressing the “enter” key.

Once the customer provides the requested information and the card management system 44 verifies the information, a selection menu is displayed on the viewing screen 36 in act 60. The selection menu displays a number of templates for personalizing the gift card 10 for a specific occasion. For example, the selection menu can include templates for a traditional Christmas theme, a modern Christmas theme, a child birthday theme, an adult birthday theme, a wedding theme, a wedding anniversary theme, a Hanukkah theme, a Valentine's Day theme, a graduation theme, etc. Each of the templates has a different appearance and/or design and allows the customer to display data on the gift card 10 in a unique and aesthetically pleasing manner. Some of the templates are designed to cover the entire front or back side 16, 18 of the gift card 10 with a given design, other templates are designed to cover both the front and back sides 16, 18 of the gift card 10, and still other templates are designed to cover portions of one or both of the front and back sides 16, 18 of the gift card 10 with a given design. Additionally, each of the templates has data entry fields, which correspond to one or more of the data fields 24B, 24C on the gift cards 10. As explained in greater detail below, the customer can personalize the gift card 10 by entering personalized data in the form of text messages and/or graphic images into one or more of the data entry fields.

The selection menu includes instructions that direct the customer to select one of the templates by pressing the appropriate button on the keyboard 42C. For example, the selection menu can instruct the customer to press the “A” key to select the traditional Christmas template, to press the “B” key to select the modem Christmas template, to press the “C” key to select the child birthday template, etc. Once the customer selects a template, the card management system 44 displays the customer-selected template (e.g., the traditional Christmas theme) on the viewing screen 36.

In act 62, a personalization screen is displayed on the viewing screen 36. The personalization screen includes a link to the help page and displays instructions for personalizing the gift card 10. The instructions explain that the customer can personalize the gift card 10 with text messages and/or graphic images. To enter text messages, the customer selects one of the data entry fields. Once the customer selects a data entry field, the customer can enter a text message by typing a message using the keyboard 42C, or alternately, the customer can select a pre-formatted text message from a list displayed on the personalization screen. Some examples of pre-formatted text messages include, “Happy Birthday!”, “Merry Christmas!”, “Congratulations!”, and the like. Other pre-formatted text messages can include longer messages, similar to those on conventional greeting cards (e.g., poems, short stories, inspirational messages, and the like). Additionally, in some applications of the present invention, the customer can choose a font and/or the size and color of the font from a number of available choices.

To enter graphic images, the customer selects one of the data entry fields. Once the customer has decided on a data entry field, the customer can upload a graphic image onto the card personalization system 28. To upload a graphic image, the customer follows the instructions displayed on the personalization screen, which instruct the customer how to use the data entry tools 42. For example, in the embodiment illustrated in FIG. 3, the customer can use the scanner 42A and/or the digital camera 42B to upload a graphic image onto the personalization station 32, in a known manner. Once, the customer has uploaded an image, the customer can upload additional images by following a similar procedure. If desired, the customer can adjust the location, size, and/or relative position of the data entry fields, using arrow keys (not shown) on the keyboard 42C. The customer may also elect to have the image cover the entire front and/or back side(s) 16, 18 of the card 10.

After the customer has entered text messages and/or graphic images (referred to hereafter collectively as “personalized data”) in the data entry fields, the customer presses the “enter” key, transmitting the completed template to the card management system 44. In act 66, the card management system 44 verifies the personalized data submitted by the customer and determines if the personalized data submitted by the customer is valid by comparing the personalized data to a preprogrammed template or format in a known manner. For example, the card management system 44 determines whether or not all of the personalized data is in a valid format and whether or not the personalized data fits on the gift card 10. If any of the personalized data is determined to be invalid (“NO” at act 66), an error message is displayed and the customer is prompted to re-enter or correct the data. If the personalized date is valid (“YES” at act 66), a billing screen is displayed on the viewing screen 36 in act 68.

The billing screen prompts the customer to select a payment option. In the illustrated embodiment, the customer can pay in cash, or alternatively, the customer can decide to use a credit card or a debit card. Additionally, the billing screen displays the monetary value for the gift card 10 that the customer selected in act 54 and gives the customer the option of changing the monetary value.

To pay in cash, the customer follows the instructions for paying in cash and inserts money into the money slot 38 in a known manner. To pay with a credit card or a debit card, the customer follows the instructions for paying with a credit card or a debit card and completes an on-screen billing form. The billing form includes data entry fields for a credit card name (e.g., Visa, MasterCard, American Express, Discover, etc.), the card holder name, the card number, the card expiration date, the type of card (e.g., a credit card or a debit card), and the amount of money that the customer would like credited to the gift card 10. Once the customer has completed the billing form, the customer is instructed to press the “enter” key to submit the billing information to the card management system 44.

In act 70, the card management system verifies the billing information in a known manner. If any of the billing information is determined to be invalid (“NO” at act 70), the customer is prompted to re-enter or correct that information. If the billing information is valid (“YES” at act 70), the customer is allowed to proceed.

Once the customer has selected a payment option and the card management system 44 has accepted payment, the card management system 44 assigns a random alphanumeric identifier to the personalized data and creates an account in act 72. The account is identified by the alphanumeric identifier and is credited with the dollar value selected by the customer in act 54 or act 68. The card management system 44 stores the account information, including the identifier and the dollar value credited to the account, in a database. As shown in FIG. 3, in some applications, the stores A, B, C can access the account information via the network 46. Therefore, when the card 10 is used to make a purchase, the purchase amount can be debited directly from the account. In one embodiment, the programming station 32 is at the point of purchase and is integrated within the programming station 32. In this embodiment, the programming station 32 is a gift card dispenser and the only data transferred between the card management system 44 and the programming station 32 is the dollar value input by the customer and assigned to the gift card 10.

In act 76, the card management system 44 transmits the personalized data and the identifier to the printer 41, which prints, embosses, or laminates the specified images onto the gift card 10. Such printing equipment is commonly known and used in the manufacture of credit, debit, and identification cards. The printer 41 may also be a thermal head printer housed in the programming station 32, an inkjet printer, a laser printer, or various other suitable substitutes. Also, in some embodiments, the printer 41 can be positioned outside the programming station 32 and can be connected to the programming station 32 with cables (not shown). The printer 41 prints personalized data in the appropriate data entry fields 24C, 24C and prints the identifier on the gift card 10 in the identification number field 20. Additionally, in some embodiments, a data encoder (not shown) encodes data (e.g., account information, the customer's name, a card expiration date, and the like) on the magnetic strip 25. In other embodiments, the programming station 32 can encode the account information in a data storage chip (not shown), which is imbedded in the gift card 10.

Once act 76 is completed, the programming station displays a message alerting the customer that the gift card 10 is ready and instructing the customer to remove the gift card from the card dispenser 40. The gift card 10 can then be used instead of money at any of the stores A, B, C to purchase merchandise.

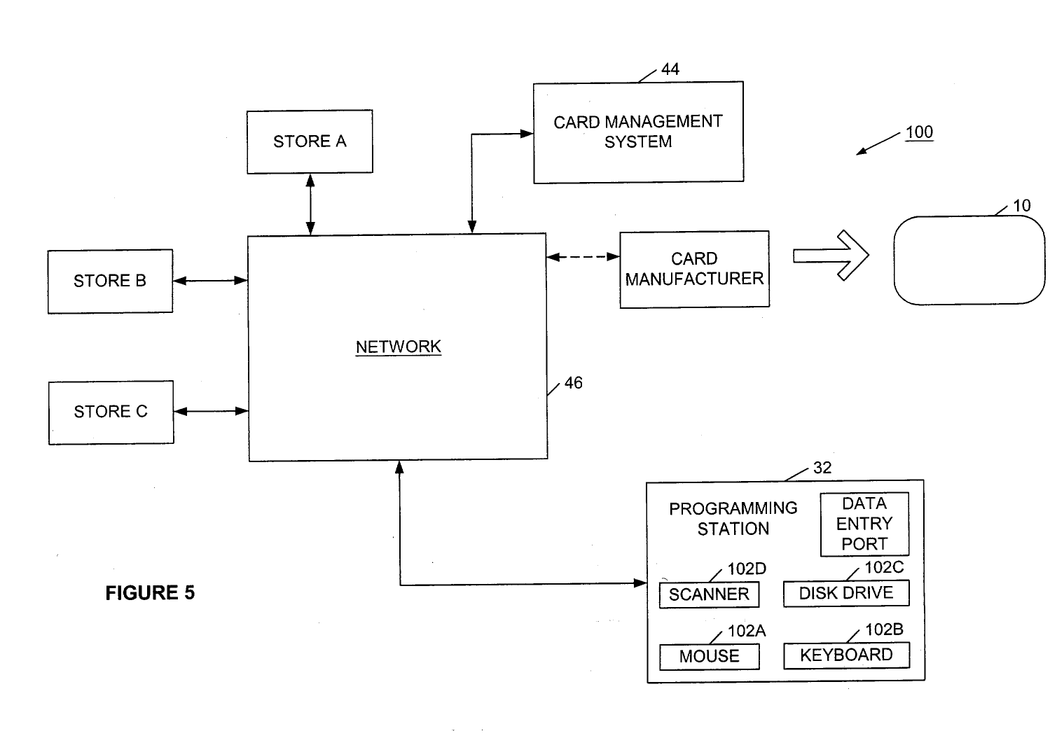

FIG. 5 illustrates a card personalization system 100 according to a second embodiment of the present invention. The card personalization system 100 of the second embodiment is substantially similar to the card personalization system 28 described above with respect to the first embodiment of the present invention. Therefore, for reasons of simplicity and clarity, only differences between the first and second embodiments will be described hereafter.

In the second embodiment, the network 46 is the internet and the programming station 32 is a personal computer, which can be located in any number of remote locations including a customer home, a public library, a store, a cafe, and the like. In the second embodiment, the programming station 32 includes a number of data entry tools 102, including a mouse 102A, a keyboard 102B, a disk drive 102C (including, for example, a CD-ROM drive), and a scanner 102D. The programming station 32 also includes a data entry port 102E such as a uniform serial bus or RS-232 port, or other connection, for receiving data from any of a variety of devices, for example, a digital camera, zip drive, or other data storage device.

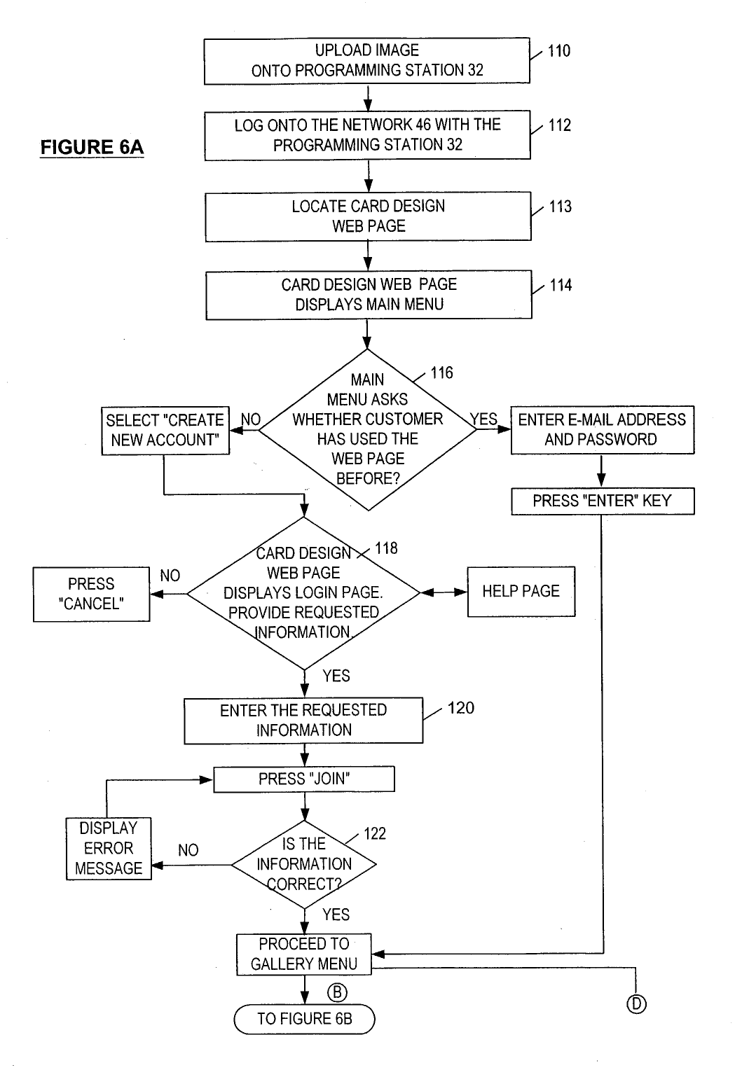

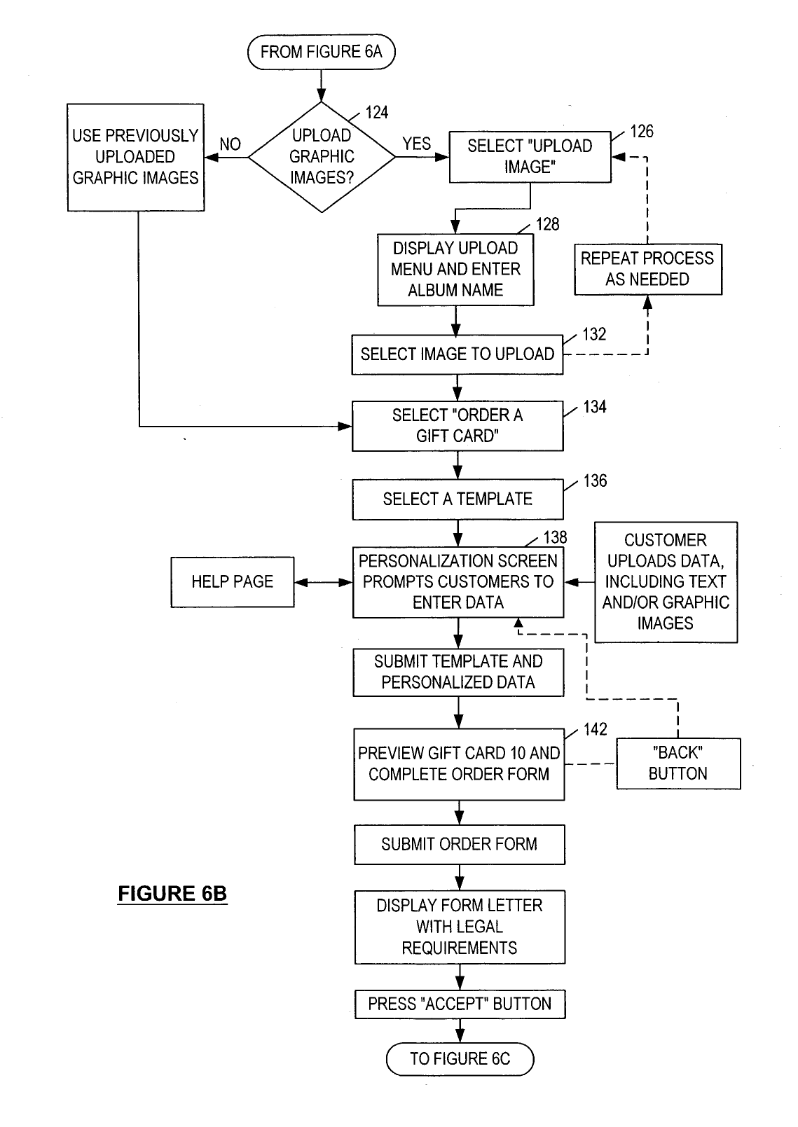

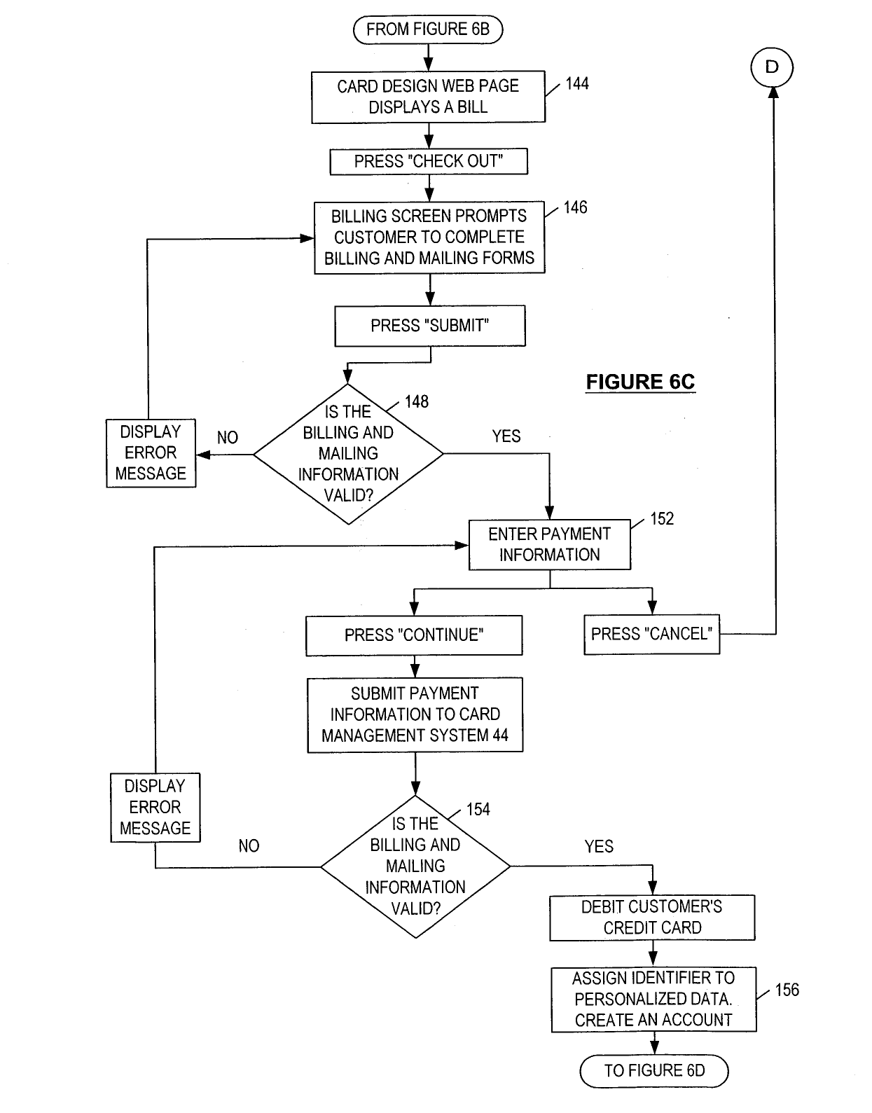

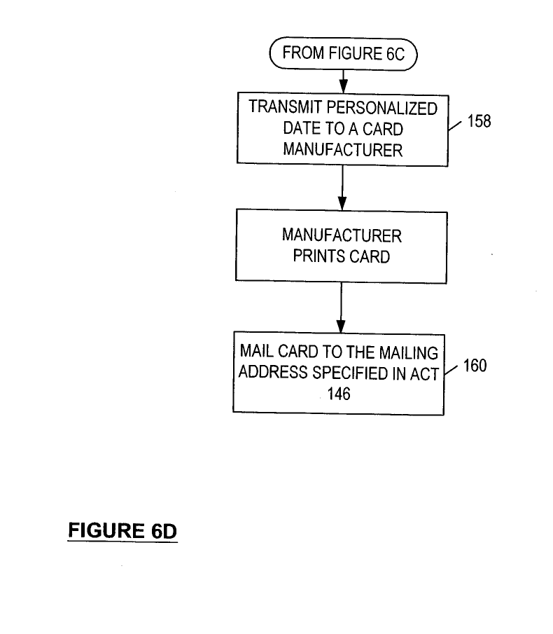

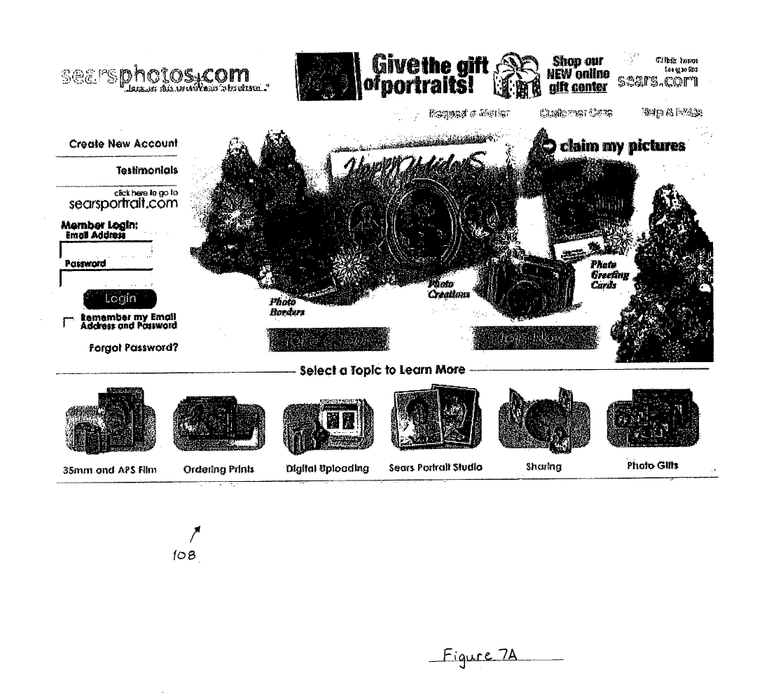

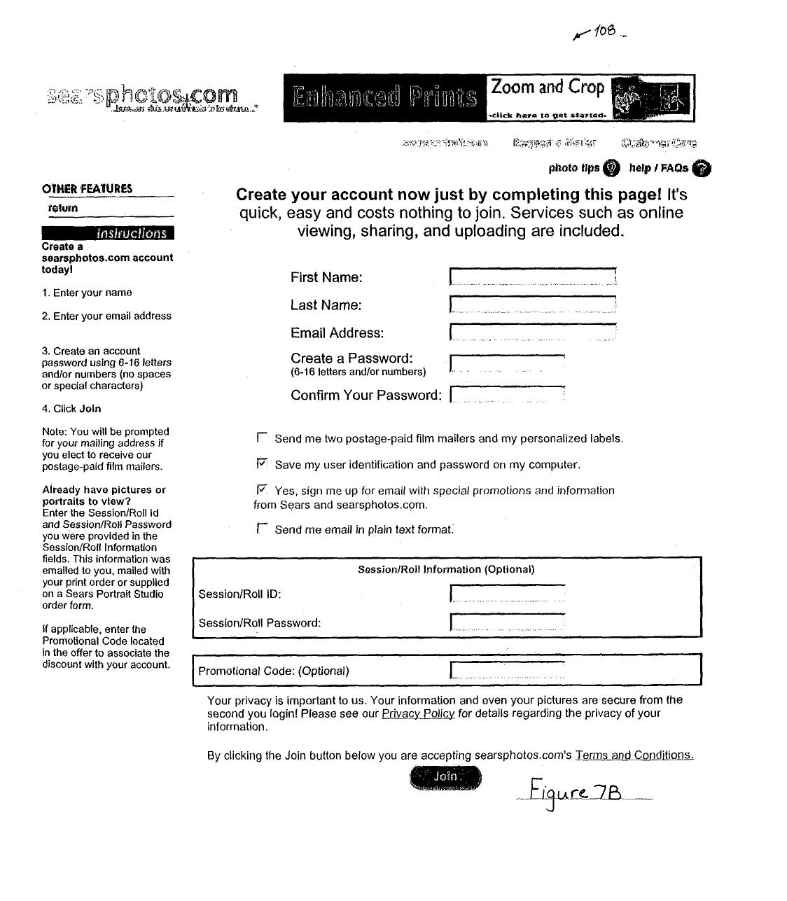

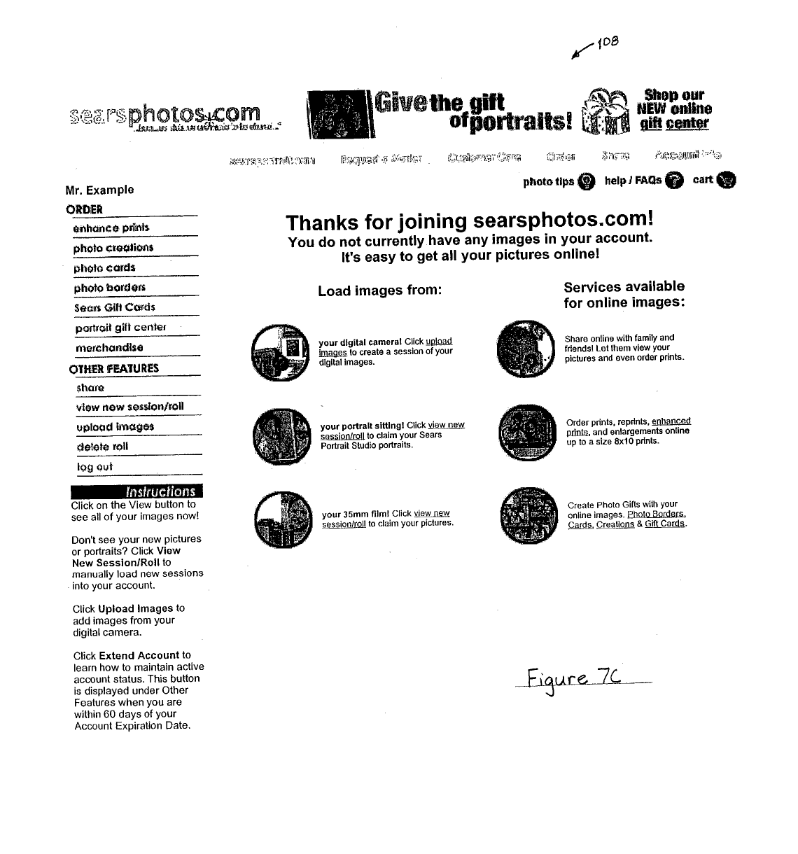

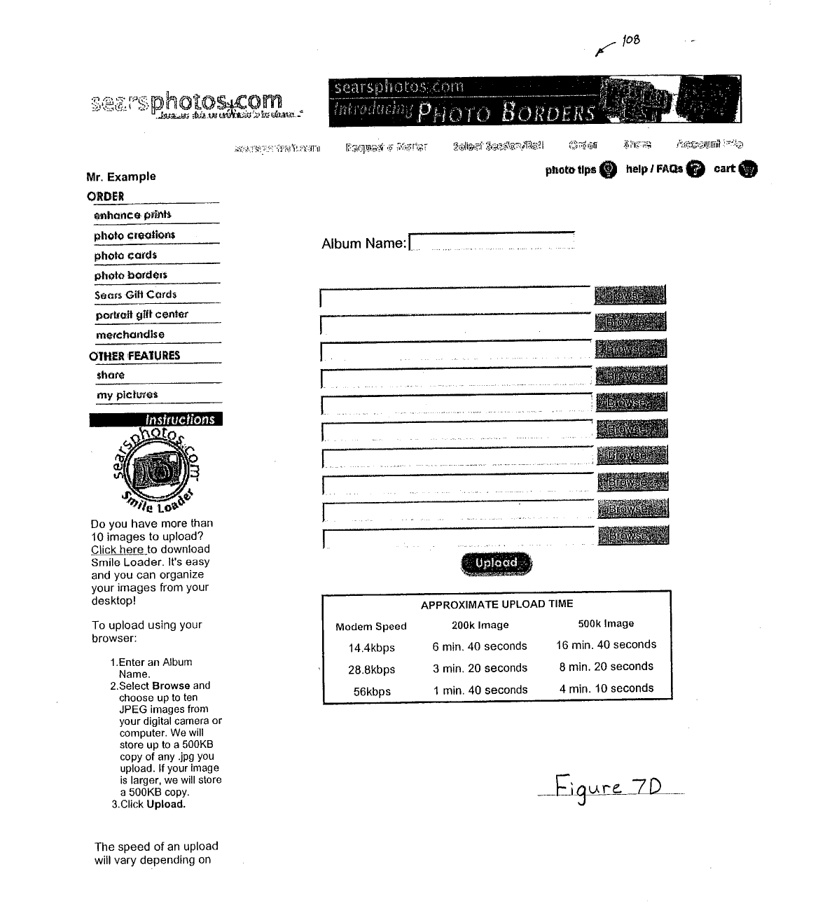

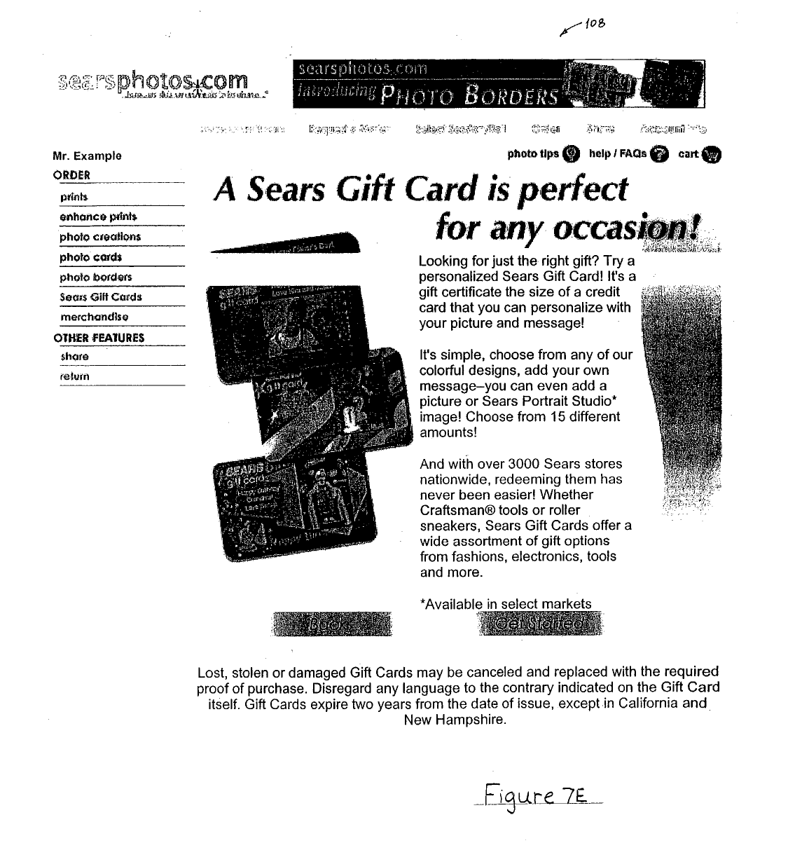

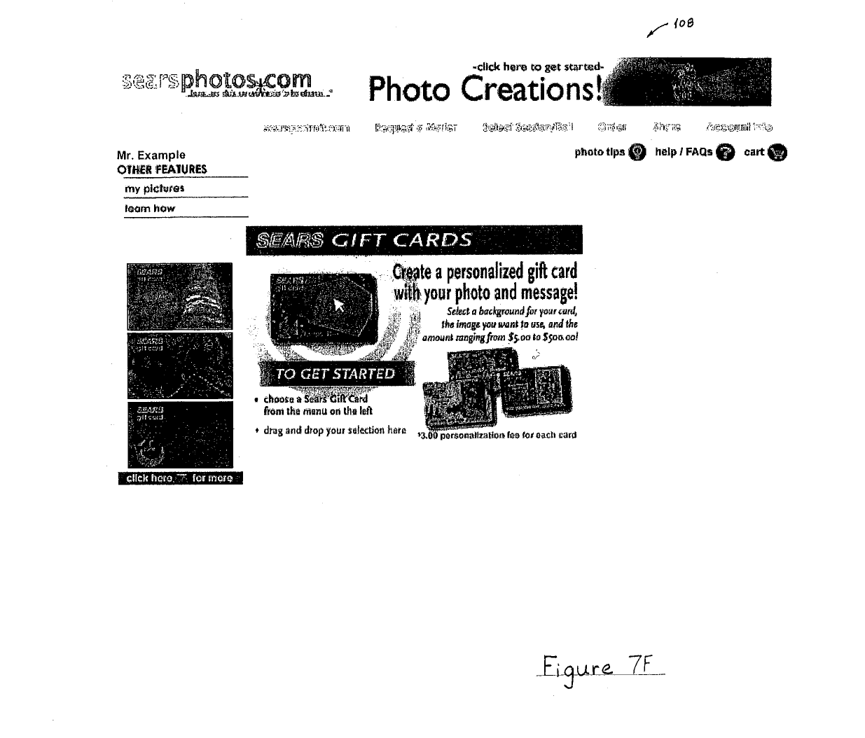

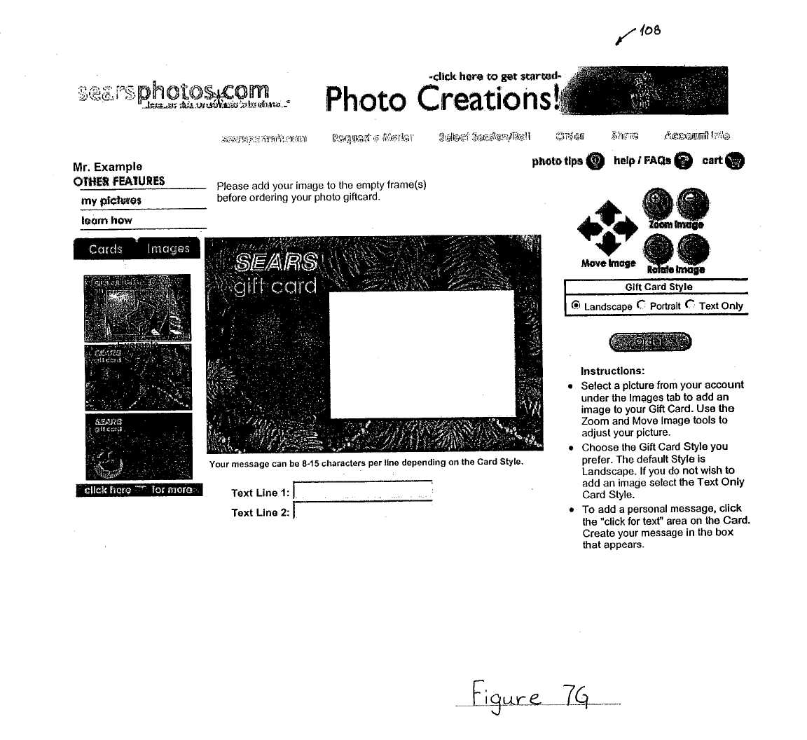

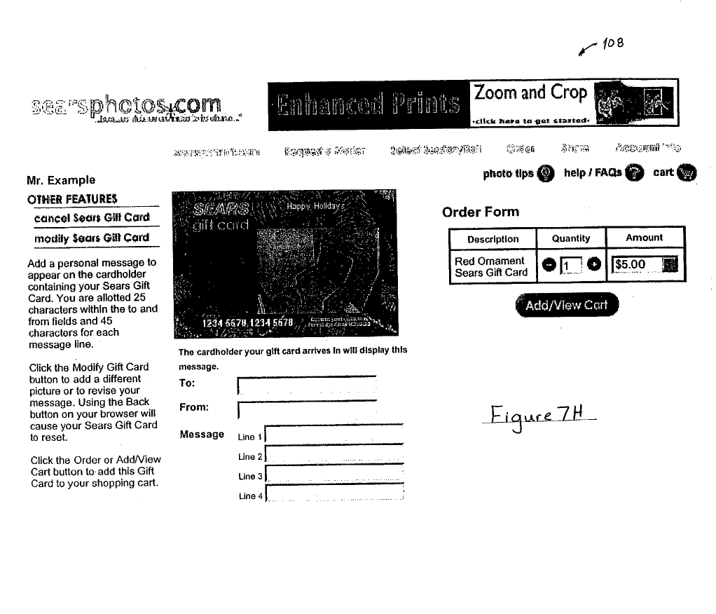

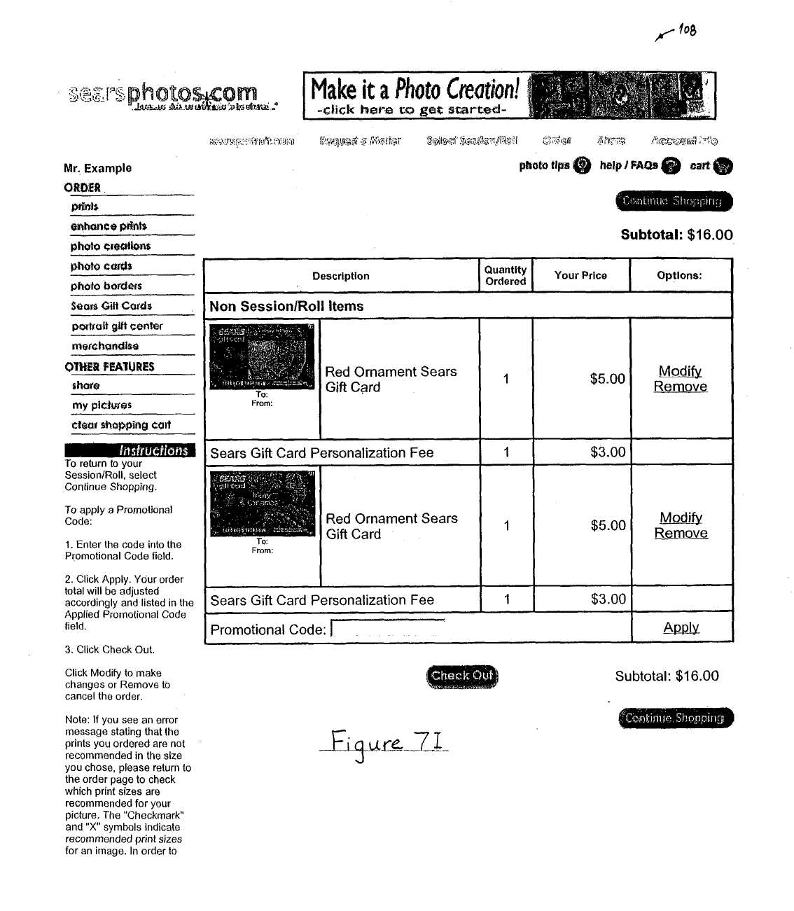

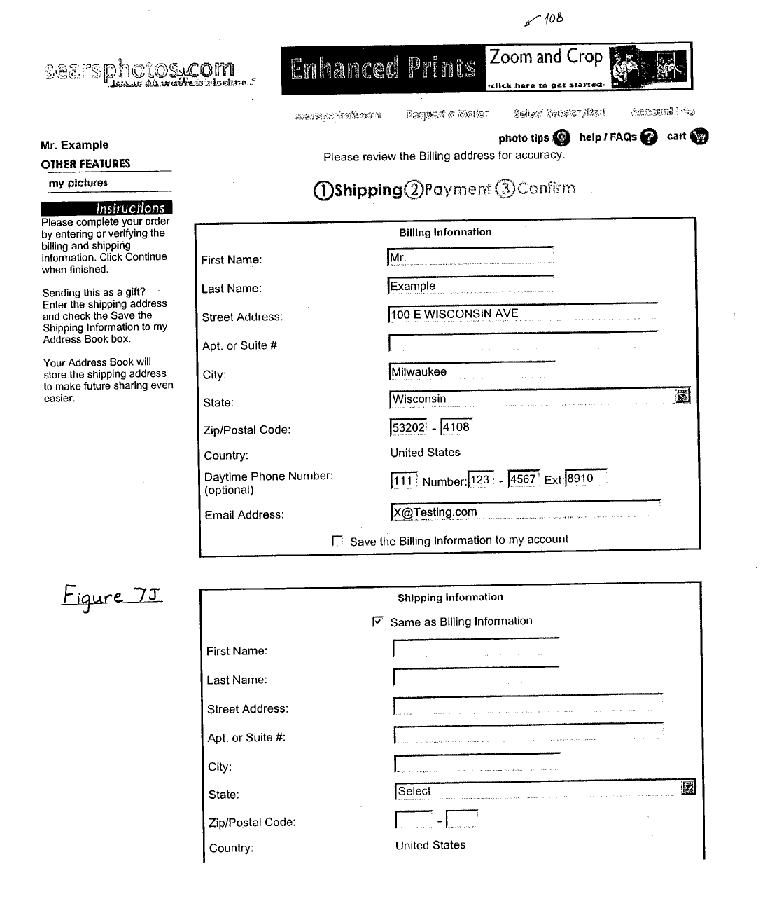

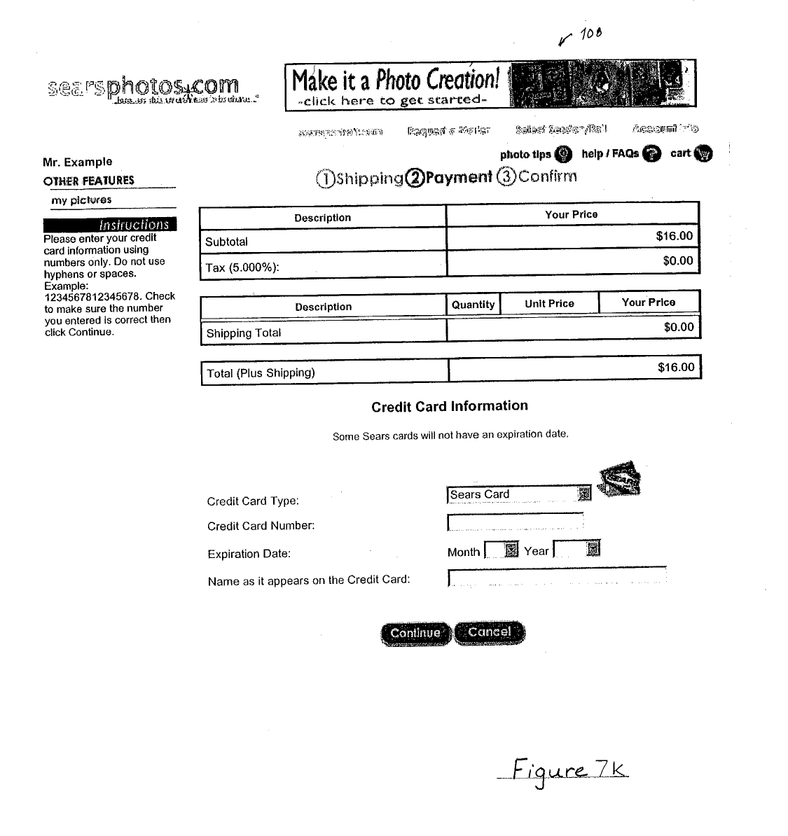

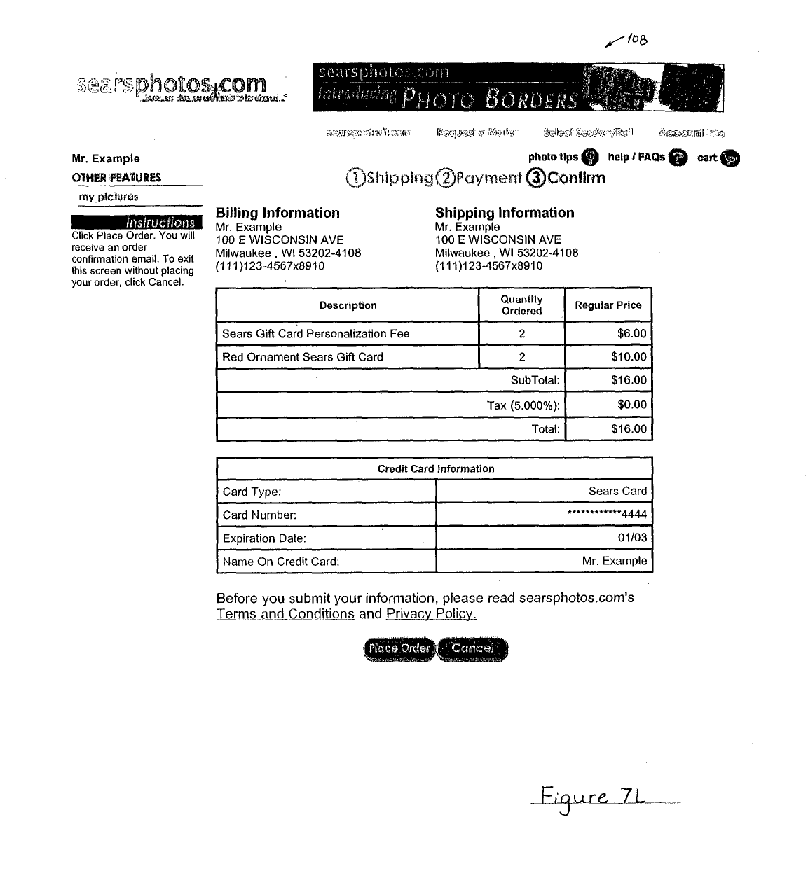

FIGS. 6A-6D show a flow chart illustrating a method for personalizing the gift card 10 with the card personalization system 100 according to a second embodiment of the present invention. The method of the second embodiment described hereafter is substantially similar to the method currently employed by Sears Roebuck and Company at www.searsphotos.com. However, the following description and the method employed by Sears Roebuck and Company are presented by way of example only and are not intended to limit the concepts and principles of the present invention. The method of the second embodiment employs a user interface 108, which is shown in FIGS. 7A-7L. The user interface 108 includes a card design web page and is described in greater detail hereafter.

With reference to FIG. 6A, in act 110, the customer uploads one or more graphic images onto the programming station 32. In different embodiments of the present invention, the customer can upload graphic images onto the programming station 32 in a number of different manners, depending, at least in part, upon the type and availability of data entry tools 102. For example, the customer can upload images from the scanner 102D and/or the disk drive 102C onto the programming station 32. The customer then saves the graphic image(s) on the programming station 32 (e.g., on a hard drive) in a commonly recognized format, such as, for example, TIFF, PDF, JPEG, and the like.

In act 112, the customer uses the programming station 32 and a modem (not shown), an Ethernet card (not shown), or a direct-connect internet line to log onto the network 46. In act 113, the customer uses a search engine or an internet address to locate the card design web page, which is connected via the network 46 to the card management system 44.

In act 114, the card design web page displays a main menu (see FIG. 7A), which includes general information about gift cards 10 and instructions for personalizing the gift card 10. In other embodiments, the card design web page can include additional descriptive or instructional materials, such as for example, advertisements for other products, legal disclaimers, and pictures of personalized gift cards 10 made according to the following method.

In act 116, the main menu (see FIG. 7) prompts the customer to enter an e-mail address and password if the customer has used the card design web page before (“YES” at act 116), or alternatively, the card design web page prompts first-time users to enter a login page to create a new account (“NO” at act 116). If the customer has used the card design web page before, the customer enters an e-mail address and a password and presses the “enter” key, or alternately, points and clicks on a “next” button in a known manner to move onto a gallery menu (described below). To create a new account, the main menu prompts the customer to point and click on “join now” button to move to the next screen.

If the customer selects the create a new account option, the card design web page displays a login page (see FIG. 7B). The login page includes a link to a help page and instructions for creating a personalized account. At this point the customer can proceed and provide the requested information (“YES” at act 118), or alternatively, the customer can exit the system (“NO” at act 118). If the customer is still interested in proceeding, the customer is directed to follow the instructions displayed on the login page and to enter the requested information into the data entry fields in act 120. The login page includes data entry fields for the customer to enter a first and last name, an e-mail address, and a password. In other embodiments, the login page can ask for additional information, such as, for example a mailing address, a telephone number, the name of the intended recipient, a billing address, a credit card number, a credit card name, a credit card expiration date, and an amount of money that the customer wants credited to the gift card 10. Once the customer provides all of the required information, the customer is prompted to press the “enter” key, or alternatively, to point and click on a “join” button to proceed. The programming station 32 then submits the customer information to the card management system 44 via the network 46.

As shown in act 122, the card management system 44 verifies the customer information, determines if the customer information is valid by comparing the customer information to a preprogrammed template or format, and verifies the information for the correct syntax in a known manner. If any of the customer information is determined to be invalid (“NO” at act 122), an error message is displayed and the customer is prompted to re-enter or correct that information. If the information is valid (“YES” at act 122), the customer is allowed to proceed to a gallery menu (see FIG. 7C).

In act 124, the gallery menu directs customers to upload graphic images in the form of photographs, paintings, drawings, and the like prior to creating a personalized gift card 10. If the customer has previously uploaded one or more graphic images onto the card design web page, the gallery menu informs the customer how many graphic images are saved on the account and allows the customer to upload additional images (“YES” at act 124), or alternately, to use previously loaded graphic images (“NO” at act 124). The gallery menu instructs customers to point and click on “order a gift card” to use previously uploaded graphic images and to by-pass the image uploading process.

To upload a graphic image (“YES” at act 124), the customer points and clicks on an icon labeled “upload images” in act 126. The card design web page then displays an upload menu (see FIG. 7D). In act 128, the upload menu instructs the customer to enter an album name, which serves as a directory name for any graphic images that the customer uploads. After the customer enters the album name, the upload menu instructs the customer to select a graphic image to upload from the programming station 32 by pointing and clicking on a button labeled “browse”. By pointing and clicking on the “browse” button, the customer can enter a file and path name corresponding to one of the graphic images stored on the programming station 32 during act 110, or alternatively, the customer can browse through the directories of the programming station 32 for other saved graphic images.

In act 132, after the customer locates a graphic image, the customer enters the file and path name into the appropriate field and points and clicks on a button labeled “upload”. The graphic image is then uploaded from the programming station 32 onto the card design web page via the network 46 in a known manner. The card design web page is programmed to recognize various types of data objects (e.g., TIFF files, PDF files, JPEG files, and the like), which can be transferred through the network 46 and can be created in accordance with an industry standard data object format, such as, for example, extensible Markup Language (XML), hypertext markup language (HTML), and the like. Acts 126, 128, and 130 can be repeated as needed or until the customer has uploaded a sufficient number of graphic images.

Once the customer has uploaded one or more graphic images onto the card design web page, the customer can point and click on an icon labeled “order a gift card” in act 134 (see FIG. 7C). The card design web page then displays an information menu (see FIG. 7E), which includes instructions for personalizing a gift card 10. After reading the instructions, the customer is instructed to press the “enter” key, or alternately, to point and click on the button labeled “get started” to proceed to a selection menu (see FIG. 7F). The selection menu includes a number of icons representing a number of templates for personalizing the gift card 10 for a specific occasion, as explained above with respect to the previous embodiment. The selection menu includes instructions directing the customer to select one of the templates by pointing and clicking on the appropriate icon in act 136. Once the customer selects a template, the card design web page displays the customer-selected template (e.g., a traditional Christmas theme). As with the previously described embodiment, each of the templates includes one or more data entry fields, which allow the customer to enter personalized data in the form of text messages and/or graphic images. Each of the data entry fields preferably correspond to one of the data fields 24B, 24C on the gift card 10, as explained below.

In act 138, the card design web page displays a personalization screen (see FIG. 7G). The personalization screen includes a link to the help page and displays instructions for personalizing the gift card 10. Additionally, the card personalization screen displays miniature versions of each of the graphic images, which have been uploaded onto the customer account. The instructions explain that the customer can personalize the gift card 10 with text messages and/or graphic images. To enter text messages, the customer selects one of the data entry fields by pointing and clicking on the appropriate data entry field in a known manner. Once the customer selects a data entry field, the customer can enter a text message by typing a message on the keyboard 102B, or alternately, the customer can select a pre-formatted text message from a list displayed on the personalization screen.

To enter graphic images, the customer follows the instructions displayed on the personalization screen, which instruct the customer to select one of the uploaded graphic images by pointing and clicking on the image. The customer is then instructed to drag the graphic image to one of the data entry fields. The customer can then adjust the size and relative position of the image using arrows located on the personalization screen. The customer can also rotate the graphic image with respect to the template using buttons located on the personalization screen. Additionally, by clicking on an icon labeled “zoom in” the customer can enlarge a particular portion of the graphic image, or alternatively, by pointing and clicking on an icon labeled “zoom out” the customer can zoom out from the enlarged portion of the graphic image.

After the customer has entered text messages and/or graphic images (referred to hereafter collectively as “personalized data”) in the data entry fields, the customer presses the “enter key”, or alternately, points and clicks on a button labeled “order”, transmitting the completed template across the network 46 to the card management system 44. The card design web page then displays an ordering screen in act 142.

The ordering screen (see FIG. 7H) displays a copy of the personalized gift card 10 and includes instructions for paying for the gift card 10. In some embodiments, the ordering screen also includes a button labeled “back”. In these embodiments, the customer can point and click on the “back” button to return to the personalization screen to modify the gift card 10. If the customer is satisfied with the appearance of the gift card 10, the customer is instructed to complete an order form, which is displayed on the ordering screen. The order form includes data entry fields for the customer to enter an amount of money that the customer wants credited to the gift card 10, the number of gift cards 10 that the customer wants to order, and one or more message fields. Instructions on the ordering screen explain that information entered in the message fields will be displayed on a card holder, which will be mailed with the gift card 10 to the customer or to the intended recipient. After the customer has completed the order form, the customer is directed to press the “enter” key, or alternately, to point and click on a button labeled “submit”. The ordering screen then displays a form letter listing legal requirements, duties, privacy policies, and the like. To continue, the customer is required to point and click on a button labeled “accept”, indicating that the customer has read and understands the legal requirements, duties, and privacy policy and accepts the same.

In act 144, the card design web page displays a bill (see FIG. 7I), itemizing the cost of the gift card 10, any applicable taxes, and any other applicable fees (e.g., a personalization fee). The customer is then prompted to point and click on a button labeled “check out” to proceed to a billing screen (see FIG. 7J-7L).

In act 146, the billing screen prompts the customer to complete an on-screen billing form (see FIG. 7J). The billing form includes data entry fields for the customer's street address, the customer's city and state, the customer's zip code, the customer's e-mail address, and a daytime phone number. Once the customer has completed the billing form, the customer is instructed to complete a mailing form (see FIG. 7J). The mailing form includes data entry fields for a mailing address for the gift card 10 (e.g., the customer's address or the intended recipient's address). The customer is then instructed to point and click on a button labeled “submit” to submit the billing form and the mailing form to the card management system 44. The card management system then verifies the billing information and mailing address in a known manner in act 148. If any of the billing information or mailing information is determined to be invalid (“NO” at act 148), the card design web page displays an error message and the customer is prompted to re-enter or correct that information. If the billing and mailing information is valid (“YES” at act 148), the customer is allowed to proceed to a payment screen (See FIG. 7K).

In act 152, the card design web page displays the payment screen and prompts the customer to enter a credit card name (e.g., Visa, MasterCard, American Express, Discover, etc.), the name on the card, the card number, and the card expiration date. After the customer provides all of the information required by the payment screen, the customer is prompted to point and click on a button labeled “continue” to order the gift card 10, or alternately, to point and click on a button labeled “cancel” to cancel the transaction. If the customer presses the “cancel” key, the card design web page returns to the gallery menu, at which time the customer can either exit the card design web page or the customer can re-design a new gift card 10. If the customer presses the “continue” key, the card design web page submits the payment information to the card management system 44.

In act 154, the card management system 44 verifies the payment information in a known manner. If the card management system 44 determines that the payment information is invalid (“NO” at act 154), the card design web page displays an error message, prompting the customer to re-enter or correct the payment information. If the card management system 44 determines that the payment information is valid (“YES” at act 154), the card management system 44 debits the customer's credit card for the amount shown on the bill in act 144. After the customer's credit card is charged for the amount shown on the bill, the card design web page displays a confirmation form (see FIG. 7L), which includes the billing information, the shipping information and the amount charged to the customer's credit card.

After the card management system 44 has charged the customer for the gift card 10, the card management system 44 assigns a random alphanumeric identifier to the personalized data and creates an account in act 156. The account is identified by the alphanumeric identifier and is credited with the dollar value selected by the customer in act 142. The card management system 44 stores the account information, including the identifier and the dollar value credited to the account, in a database.

In act 158, the card management system 44 transmits the personalized data and the mailing address to a card manufacturer. The card manufacturer uses a card printer (not shown) to print the personalized data on the gift card 10 in the form of images and text messages in a known manner using an inkjet, thermal head, laser, or other suitable print mechanism. Additionally, the manufacturer prints the alphanumeric identifier in the identification number field 20. The card manufacturer also uses a data encoder to encode data (e.g., account information, the customer's name, a card expiration date, and the like) on the magnetic strip 25. In act 160, the manufacturer mails the personalized gift card 10 to the mailing address specified in act 146 (e.g., the customer's address or the intended recipient's address). The intended recipient can then use the gift card 10, instead of cash, to purchase merchandise in stores.

The embodiments described above and illustrated in the drawings are presented by way of example only and are not intended as a limitation upon the concepts and principles of the present invention. For example, as described above, the present invention can be used to personalize a gift card 10 with customer-specified graphic images. However, the present invention can also or alternately be used to design gift cards 10, which have personalized text messages and do not have personalized graphic images. As such, it will be appreciated by one having ordinary skill in the art, that various changes in the elements and their configuration and arrangement are possible without departing from the spirit and scope of the present invention as set forth in the appended claims. Also, the functions of the various elements and assemblies of the present invention can be changed to a significant degree without departing from the spirit and scope of the present invention.

In both embodiments, the method is effected using software that is stored entirely either at the programming station 32, on servers supporting the network 46, or in the card management system 44; or is stored in parts on any combination of these components. The system and method are useful to allow customers to purchase and customize financial transaction cards either from remote computers or at point of purchase dispensing stations.

Various features and advantages of the invention are set forth in the following claims.

What is claimed is:

1. A method of making a personalized financial transaction card having a customer-specified image on the card, the method comprising:
providing a programming station for access by the customer, the programming station including a data entry tool;
providing a card account management system connected to the programming station, the card account management system including a database of account data relating to the customer;
entering data representing the customer-specified image into the programming station using the data entry tool;
transmitting the data from the programming station to the card account management system; and
generating a personalized financial transaction card related to the account data and bearing the customer-specified image on the personalized financial transaction card.

2. The method of claim 1, wherein the programming station is located in a store.

3. The method of claim 1, wherein the programming station is a personal computer located in a customer home.

4. The method of claim 1, wherein a network connects the programming station and the card account management system, the method further comprising transmitting the customer-specified image from the programming station across the network to the card account management system.

5. The method of claim 1, further comprising:
providing a customer account having an identifier;
uploading the identifier to the programming station;
specifying a monetary value for the personalized financial transaction card;
debiting the monetary value from the account using the identifier; and
crediting the monetary value to the personalized financial transaction card.

6. The method of claim 5, wherein the personalized financial transaction card includes a second identifier and crediting the monetary value to the personalized financial transaction card includes:
creating a second account;
linking the second account to the second identifier; and
accessing the second account with the personalized financial transaction card.

7. A system for allowing a customer to make a personalized financial transaction card having a customer-specified image on the card, the system comprising:
a programming station including a data entry tool that allows the customer to enter into the programming station data representing the customer-specified image;
a card account management system connected to the programming station, the card account management system including a database of account data relating to the customer; and
means for generating a personalized financial transaction card related to the account data and bearing the customer-specified image on the personalized financial transaction card.

8. The system of claim 7, further comprising a network connecting the means for generating a personal financial transaction card and at least one of the card management system and the programming station.

9. The system of claim 7, wherein the programming station includes a money slot.

10. The system of claim 7, wherein the data entry tool is a digital camera.

11. The system of claim 7, wherein the data entry tool is a scanner.

12. The system of claim 7, further comprising a data entry port.

13. The system of claim 7, wherein the card account management system is connected to a plurality of stores for transferring account data to the plurality of stores.

14. The system of claim 7, further comprising a tool for accepting a monetary value paid by the customer for the personalized financial transaction card.

15. A software program stored on computer readable medium for generating a virtual site accessible by a customer and for generating a financial transaction card based on information provided by the customer, the software program comprising:
a program module for acquiring and storing image or text data specified by the customer;
a program module for assigning a monetary value based on a monetary value data entered by the customer; and
a program module for combining the image or text data with the monetary value data and generating a financial transaction card bearing the image or text data on the face of the card and having the monetary value encoded on the card.

16. The software program of claim 15, wherein the program module for acquiring and storing image or text data specified by the customer assigns an identifier to the image or text data specified by the customer, and wherein the image or text data specified by the customer is accessible or recallable based on the identifier.

17. The software program of claim 15, wherein the program module for acquiring and storing image or text data specified by the customer stores a plurality of standardized templates, and wherein the standardized templates are customer accessible.

18. The software program of claim 15, further comprising a program module for verifying the image or text data specified by the customer.

19. The software program of claim 15, further comprising a program module for charging the monetary value to the customer.

20. An internet website accessible by a customer desiring to purchase a financial transaction card, the website comprising:
a graphical user interface including means for inputting a customer provided image or text for ultimate transfer to the face of the financial transaction card.

21. The internet website of claim 20, further comprising means for storing and recalling the customer provided image or text.

22. The internet website of claim 20, further comprising a second user interface including means for charging the customer for the personalized financial transaction card.

23. The internet website of claim 21, further comprising a plurality of standardized templates for formatting the customer provided image or text.

24. The internet website of claim 20, wherein the website is connected to a database of account data relating to the customer.

25. A point-of-purchase gift card dispenser comprising:
a digital camera for acquiring an image presented by a customer purchasing the gift card;
a tool for accepting a monetary value paid by the customer for the gift card; and
a card dispenser for combining the image on the face of the gift card, encoding the monetary value on the gift card and dispensing the gift card to the customer at the point of purchase.

26. The point-of-purchase gift card dispenser of claim 25, further comprising a card account management system including a database of account data relating to the customer.

27. The point-of-purchase gift card dispenser of claim 26, wherein the card account management system stores the image presented by the customer and relates the image presented by the customer with an identifier.

28. The point-of purchase gift card dispenser of claim 25, wherein the tool for accepting the monetary value paid by the customer for the gift card includes a money slot.

29. The point-of-purchase gift card dispenser of claim 25, wherein the tool for accepting the monetary value paid by the customer for the gift card includes a card swipe.

30. The point-of-purchase gift card dispenser of claim 25, further comprising a scanner for acquiring the image presented the customer purchasing the gift card.

31. The point-of-purchase gift card dispenser of claim 25, further comprising a data entry tool for acquiring a text message presented by the customer purchasing the gift card.
